(19) United States
(12) Patent Application Publication
(10) Pub. No.: US 2010/0050374 A1
(43) Pub. Date: Mar. 4, 2010

(54) GROMMET AND METHOD OF PRODUCTION

(75) Inventor: Dave Abare, Plaistow, NH (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: New England Die Cutting, Inc., Haverhill, MA (US)

(21) Appl. No.: 12/200,372

(22) Filed: Aug. 28, 2008

(51) Int. Cl. F16L 5/00; B28B 11/16

(52) U.S. Cl. 16/2.1; 264/145

(57) ABSTRACT

A device, system, and method for producing a flexible grommet for use against edges of an aperture. The exemplary method may involve producing a straight piece of flexible material with a U-shaped profile having two wall portions coupled by a central portion wherein an interior U-shaped profile is sized to produce a frictional fit with the edge of the aperture. Multiple slits may be produced in the wall portions at location of curves when the grommet is positioned within the aperture. The straight piece of flexible material may be bent along the slits. The grommet may be positioned within the aperture.

### TECHNICAL FIELD

The present invention relates to flexible grommets and more particularly, relates to method of producing grommets pieces.

### BACKGROUND INFORMATION

Grommets are often made of a soft flexible material. The grommets may be used to protect and prevent abrasions on edges of material. For example, a hole in an equipment casing of sheet metal may utilize a grommet to protect the wire. The grommet includes a U-shaped profile that sandwiches the edges of sheet metal around the perimeter of an aperture. The wire runs within the grommet and contact of the softer rubber instead of the sharp edge of the sheet metal or rigid housing.

The grommets may be molded into the desired shape of the edge or hole for the desired application. In this case the molded piece by design has the desired shape. The grommet is temporarily deformed and maneuvered into place. Since the grommet or trim pieces are made of soft or flexible material deforming the grommet or trim pieces does not present a problem.

The molded grommets and trim often require an initial expense of constructing a mold to the desired shape and size of the edge or hole. Production involving limited quantities may be prohibitive due to the costs associated with producing a mold. Accordingly, there is a need to produce a grommet or trim that allows for production without the cost of producing a mold and that may utilize stock pieces in construction of customized grommets. In addition, there is a need to produce a grommet or trim that allows for efficient insertion of the grommet into apertures and maintain the grommet within apertures.

### SUMMARY

The present invention is a novel device, system, and method of producing a flexible grommet for use against edges of an aperture. An exemplary embodiments, according to the present invention, involves producing a straight piece of flexible material with a U-shaped profile having two wall portions coupled by a central portion wherein an interior U-shaped profile is sized to produce a frictional fit with the edge of the aperture. Multiple slits may be produced in the wall portions at location of curves when the grommet is positioned within the aperture. The straight piece of flexible material may be bent along the slits. The grommet may be positioned within the aperture.

In an alternative embodiment, a length of the slits is less than half a height of the wall portion. In another embodiment, the flexible material is rubber. In another embodiment, the aperture has a rectangular shape with rounded sides. In yet another embodiment, the act of producing a straight piece of flexible material with a U-shaped profile involves extruding the material.

The present invention is not intended to be limited to a system or method that must satisfy one or more of any stated objects or features of the invention. It is also important to note that the present invention is not limited to the exemplary or primary embodiments described herein. Modifications and substitutions by one of ordinary skill in the art are considered to be within the scope of the present invention, which is not to be limited except by the following claims.

### BRIEF DESCRIPTION OF THE DRAWINGS

These and other features and advantages of the present invention will be better understood by reading the following detailed description, taken together with the drawings herein:

FIG. 1A is a profile view of the grommet bent into shape according to an exemplary embodiment of the invention.

FIG. 1B is a cross-sectional view of the grommet according to an exemplary embodiment of the invention.

FIG. 1C is a profile view of the grommet according to an exemplary embodiment of the invention.

### DETAILED DESCRIPTION

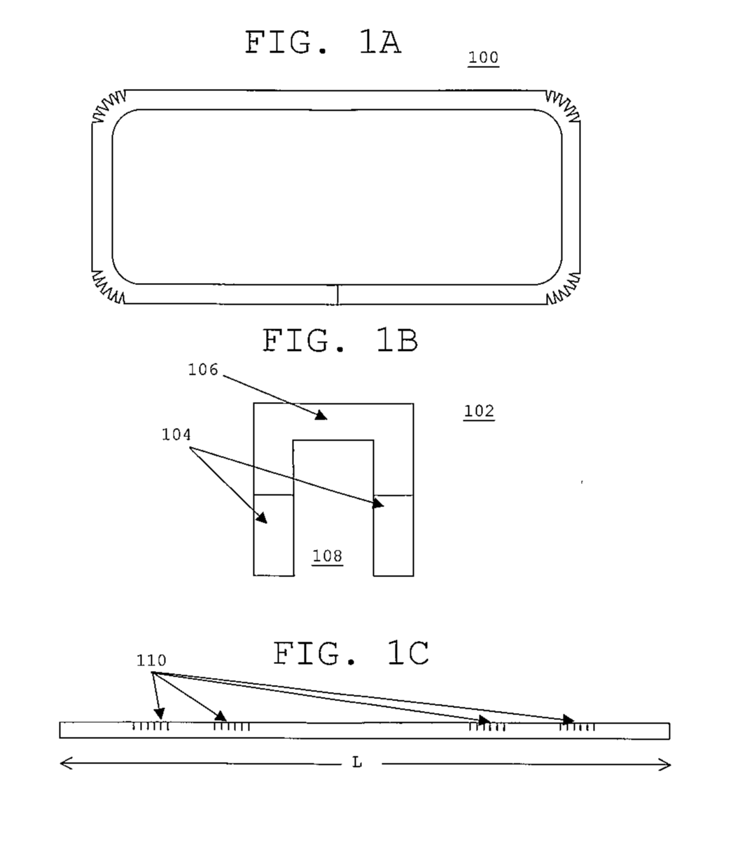

Referring to FIGS. 1A, 1B and 1C, a grommet 100 is produced to fit within an aperture. The grommets or trim pieces 100 may be used to protect and prevent abrasions on edges of material of an aperture. The grommet 100 has a profile, as shown in FIG. 1B that is designed to fit around the edge of the aperture. In the exemplary embodiment the profile is a U-shape. The U-shape has two lateral walls 104 with a central portion 106 coupling the walls 104. The edge of the aperture fits within the mouth 108 of the U-shape. The walls 104 may produce a frictional fit that holds the grommet 100 in place after positioned with in the aperture. In addition or in place of a frictional fit, glue or adhesive may be used to hold the grommet 100 in place after positioned within the aperture.

The grommet 100 may be made of a flexible material, for example, rubber or soft plastics. The flexible material may be produced using an extrusion of material from a mold. The mold produces the desired profile, as shown in FIG. 1B. The profile is not limited to the U-shape profile as disclosed in the exemplary embodiment. The exemplary aspects of the grommet and method of manufacture allows for large quantities of flexible material without knowledge of the aperture profile.

Slits 110 are cut into the walls 104 of the flexible material. The location, number, and size of the slits 110 may be selected based on the angle of the curve and location. In the exemplary embodiment six slits are produce for the ninety degree angled curve of the exemplary grommet 100. More or less slits 110 may be used depending on the grommet 100 within the aperture and the application of the grommet 100. More slits 110 may allow the grommet 100 to fit more easily within the curve. In addition, the longer the slit 110 the easier the grommet 100 may fit within the curve; however, the longer the slit 110 the less lateral strength increasing the risk the grommets 100 may accidentally be pushed from the aperture. Since the flexible material is flexible the grommet 100 may be pushed into the aperture without any slits 110; however, the addition of slits allows the grommet 100 to be pushed into the aperture in an efficient manner.

A slit 110 that extends half the length of the wall portion 104 allows the grommet 100 to be flexibly positioned within the aperture without reducing the lateral strength of the grommet 100. The length of the slit 110 and number of slits 110 may also be designed based on the flexibility of the material used for the grommet 100, for example, a more flexible rubber may allow for less slits or for shorter slits.

The length (L) of the grommet 100 may be determined by the perimeter of the aperture. The grommet 100 is cut to length as shown in FIG. 1C. The grommet 100 may be cut slightly longer than the perimeter of the aperture. The additional length is used to provide a compressive fit once positioned within the aperture. The slits 110 and lengths may be cut using the same process. For example, as the flexible material is fed into the cutting machine slits 110 on both walls 104 of the U-shaped material may be cut as the flexible material advances. As the desired length advances the flexible material may be completely cut producing the desired length (L) of the flexible material with slits 110 cut into the desired location.

The flexible material is bent into shape as shown in FIG. 1C and forced against the edges of the aperture. This may be accomplished by, for example, starting with a first end of the grommet 100 and forcing the U-shaped mouth onto the edge of the aperture. The flexible material is force in position with the curved section of the aperture aligning with the location of slits. This may be accomplished with an installer's fingers. The installer massages the grommet 100 into place.

The aperture is not limited to any specific shape. For example the aperture may be a circle, rectangular with rounded corners, or a variety other shapes. The aperture is also not limited to concave curves. The slits 110 may be used on convex curves of an aperture as well. The aperture may include a variety of concave and convex curves creating a complex shape.

The method of construction allows for a variety of grommet shapes to be constructed in limited quantities. The method of construction allows for custom shaping of the grommet 100 without the need of a custom mold for each aperture design. The method allows for large-scale production of flexible material stock and tailored design of the grommet 100 later in the manufacturing processing.

Modifications and substitutions by one of ordinary skill in the art are considered to be within the scope of the present invention, which is not to be limited except by the following claims.

The invention claimed is:

1. A method of producing a flexible grommet for use against edges of an aperture comprising the actions of;
producing a straight piece of flexible material with a U-shaped profile having two wall portions coupled by a central portion wherein an interior U-shaped profile is sized to produce a frictional fit with the edge of the aperture;
producing multiple slits in the wall portions at location of curves when the grommet is positioned within the aperture;
bending the straight piece of flexible material along the slits; and
positioning the grommet within the aperture.

2. A method of producing a flexible grommet of claim 1, wherein in a length of the slits is less than half a height of the wall portion.

3. A method of producing a flexible grommet of claim 1, wherein the flexible material is rubber.

4. A method of producing a flexible grommet of claim 1, wherein the aperture has a rectangular shape with rounded sides.

5. A method of producing a flexible grommet of claim 1, wherein the act of producing a straight piece of flexible material with a U-shaped profile involves extruding the material.

6. A flexible grommet for use against edges of an aperture comprising: a straight piece of flexible material with a U-shaped profile having two wall portions coupled by a central portion wherein an interior U-shaped profile is sized to produce a frictional fit with the edge of the aperture wherein the wall portions have multiple slits in the wall portions at location of curves when the grommet is positioned within the aperture and the straight piece of flexible material is sized to fit within the aperture and bending along the profile of the aperture.

7. A flexible grommet of claim 6, wherein in a length of the slits is less than half a height of the wall portion.

8. A flexible grommet of claim 6, wherein the flexible material is rubber.

9. A flexible grommet of claim 6, wherein the aperture has a rectangular shape with rounded sides.

10. A flexible grommet of claim 6, wherein the act of producing a straight piece of flexible material with a U-shaped profile involves extruding the material.

11. A method of producing a rubber grommet for use against edges of an aperture comprising the actions of:
extruding a straight piece of rubber with a U-shaped profile having two wall portions coupled by a central portion wherein an interior U-shaped profile is sized to produce a frictional fit with the edge of the aperture;
producing multiple slits in the wall portions at location of curves when the grommet is positioned within the aperture wherein a length of the slits is less than half the height of the wall portion;
bending the straight piece of rubber along the slits;
positioning the grommet within an aperture; and
pressing the U-shaped profile of the straight piece of rubber against the edge of the aperture.

12. A method of producing a rubber grommet of claim 11, wherein the act of producing a straight piece of flexible material with a U-shaped profile involves extruding the material as a straight U-shaped profile strand.

13. A method of producing a rubber grommet of claim 11, wherein the aperture has a rectangular shape with rounded sides.

14. A method of producing a rubber grommet of claim 11, wherein the act of producing a straight piece of flexible material with a U-shaped profile involves extruding the material.
